(19) United States
(12) Patent Application Publication
(10) Pub. No.: US 2008/0060592 A1
(43) Pub. Date: Mar. 13, 2008

(54) Split Cooling System for an Internal Combustion Engine

(76) Inventors: Jan Mehring, Koeln (DE); Bernd Steiner, Bergisch-Gladbach (DE); Bernd Harbolla, Neuss (DE)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/853,067

(22) Filed: Sep. 11, 2007

(30) Foreign Application Priority Data
Sep. 13, 2006 (EP) 06120586.0

(51) Int. Cl. F02F 1/10

(52) U.S. Cl. 123/41.72

(57) ABSTRACT

The invention relates to a split cooling circuit (16) of an internal combustion engine (17), with a cylinder head water jacket (18) and an engine block water jacket (19) being provided. The split cooling circuit (16) has a pump (21), a radiator (22), a thermostat (23) and a heater core (24), with a coolant circulating in the split cooling circuit (16).

To considerably reduce a warm-up phase of the internal combustion engine, the thermostat (23) is arranged to simultaneously control a flow of the coolant through the engine block water jacket (19) and through the radiator (22) when the coolant exceeds a predetermined temperature.

### FIELD OF THE INVENTION

The invention relates to a split coolant circuit of an internal combustion engine, with a cylinder head water jacket and an engine block water jacket being provided, with the split coolant circuit having a pump, a radiator, a thermostat and a heater core, and with a coolant circulating in the split coolant circuit.

### BACKGROUND

It is known to be expedient for the engine block and the cylinder head of the internal combustion engine to be traversed by a coolant of a coolant circuit in each case separately or at least predominantly separately from one another. In this way, the cylinder head, which is thermally coupled primarily to the combustion chamber wall, the intake air line and the exhaust gas line, and the engine block, which is thermally coupled primarily to the wear points, can be cooled differently. It is intended with said so-called “split cooling system” (split coolant circuit) to provide that, in the warm-up phase of the internal combustion engine, the cylinder head is cooled while the engine block is not initially cooled, so that the engine block can be brought up to the required operating temperature more quickly. Split cooling circuits are to be understood not as two cooling circuits but as one cooling circuit for an internal combustion engine in which the water jacket of the cylinder head is suitably separated from the water jacket of the cylinder block. In some designs, it is possible to provide a small flow from the cylinder head water jacket to the cylinder block water jacket, with the flow quantity being small enough that it is possible to refer to a split cooling circuit.

DE 103 42 935 A1, for example, discloses an internal combustion engine having a cooling circuit with at least one first coolant duct and at least one second coolant duct which is connected in parallel with the first coolant duct. Furthermore, the internal combustion engine has throttling means, which are assigned to the coolant ducts, for influencing the coolant flow passing through the coolant ducts, and a mechanically operable coolant pump for circulating the coolant through the coolant ducts. Control means are provided which provide the actuating variables for the individual control of the throttling means.

DE 195 24 424 A1 relates to a liquid cooling arrangement of an internal combustion engine having a cooling liquid flow through a cooling liquid circuit in which are provided a cooling space, which is traversed by the cooling liquid, of the internal combustion engine, a radiator for the cooling liquid, a pump which circulates the cooling liquid, and a thermostatically controlled valve which, at a low cooling liquid temperature, reduces the cooling liquid flow through the cooling space of the internal combustion engine at a low cooling liquid temperature, reduces the cooling liquid flow through the radiator below the value of the cooling liquid flow through the cooling space of the internal combustion engine. It is however also possible for a load sensor of the internal combustion engine to be provided, which load sensor, at a high load of the internal combustion engine, counteracts the reduction of the cooling liquid flow through the cooling space of the internal combustion engine. In addition, it is possible to provide a heating heat exchanger, which is connected to the cooling liquid circuit, and an actuating means which, in the event of a start-up and/or increase in activity of the heating heat exchanger, counteracts the reduction of the cooling liquid flow through the radiator.

U.S. Pat. No. 6,823,823B2 (equivalent to DE 102 61 070 A1) discloses a water jacket structure for a cylinder head and a cylinder block of an engine, having a split cooling system fitted therein. The water jackets for the cylinder head and the cylinder block are formed separately and independent of one another, with an inlet being split between the cylinder head and the cylinder block. The cross-sectional area of said inlet is reduced in the inward direction, with positions of two outlets being moved to the cylinder head.

KR 1020040033579 A also discloses a split cooling system, with a thermostat housing being embodied as a separate object and being arranged at a rear end of the internal combustion engine. U.S. Pat. No. 6,644,248B2 (equivalent to DE 101 27 219 A1) discloses a cooling system for an internal combustion engine having at least two cylinder banks, in particular for a V engine.

DE 102 19 481 A1 is concerned with an internal combustion engine having a cylinder crankcase and a cylinder head, having a cooling water circuit with a first cooling water jacket formed in the cylinder head so as to extend between an inlet opening and an outlet opening, and with a second cooling water duct which is separate from said first cooling water jacket and is formed in the cylinder crankcase so as to extend between an inlet opening and an outlet opening, and with a common cooling water pump which is arranged in the cooling water circuit. A third cooling water duct connects the outlet opening of the first cooling water duct, which is formed in the cylinder head, to the inlet opening of the cooling water pump. A fourth cooling water duct connects the outlet opening of the cooling water pump to the inlet opening of the second cooling water duct, which is formed in the cylinder crankcase, for conveying the cooling water from the first into the second cooling water duct.

DE 196 28 542 A1 is also concerned with a split cooling system, with the cylinder head or the cylinder heads being cooled by a cooling water circuit which runs only through the cylinder head and in which a cooling water pump is inserted.

U.S. Pat. No. 4,539,942A (equivalent to DE 34 40 504 C2) is likewise concerned with the split cooling system or split cooling circuits for a cylinder block and the engine block.

EP 0 816 651 B1 is concerned with the problem of specifying a device which can reduce the heating-up time of an exhaust line and at the same time, at low load, quickly raise the temperature of the walls of the engine block to a sufficient value and hold said temperature at said value, with the aim in any case being to improve the operating conditions of the engine in all operating states. For this purpose, EP 0 816 651 B1 discloses a device for the internal combustion engine, which has a cylinder block and a cylinder head, the walls of which device are designed to delimit a first part and a second part, which is distinct from said first part, and the same cooling circuit which is separated by said walls.

U.S. Pat. No. 6,739,290B2 (equivalent to EP 1 239 129 A2) is concerned with a simple cooling system for cooling the internal combustion engine.

A conventional cooling system 1, as illustrated in FIG. 1, has both a cylinder head water jacket 2 and an engine block water jacket 3, a pump 4, a radiator 6, a thermostat 7 and a heater core 8. Furthermore, the coolant circuit 1 can have a degassing device 9, (also commonly known as an expansion tank) and connecting lines 40, 41, 42, and 43 to the individual components.

Below a specific cooling temperature of, for example 90° C., the thermostat is closed (as shown in FIG. 1) and the coolant flows through pump 4, through the two water jackets 2, 3, the heater core 8 and the thermostat 7, with the respective components being connected in series with one another. The closed thermostat, as shown in FIG. 1, disallows flow through line 40. Thus, no flow (or just leakage flow) passes through lines 40 and 42 and radiator 6.

Thermostat 7 opens when it attains a specific temperature and coolant additionally flows through lines 42 and 40 and radiator 6, which are in parallel to heater core 8. The state of thermostat 7, when open, is illustrated in FIG. 2.

Split cooling circuits of the prior art tend to be costly because of their complexity and the need for a second thermostat or a complex double-acting thermostat. It is also disadvantageous that the division of the coolant flow between the cylinder head and the engine block water jacket is fixed in both phases (thermostat closed below 90° C., thermostat open above 90° C.). This leads to an undesirably high dissipation of heat and slow warm-up of the engine block and of the oil film on cylinder walls.

### SUMMARY OF THE INVENTION

An improved split cooling circuit is disclosed in which a single-acting thermostat is located downstream of cylinder head water jacket and upstream of the heater core and the engine block water jacket. The thermostat is arranged in the cooling circuit such that coolant flows to both the heater core and the engine block water jacket when the thermostat is open. When the thermostat is closed, coolant flow to the engine block water jacket is curtailed. The cooling circuit also has a radiator arranged downstream of the engine block water jacket. The heater core and the pump are connected by a line with the heater core being upstream of the pump. A connecting line from the radiator tees into the connecting line between the pump and heater core.

By this simple means the warm-up duration of the engine block is considerably reduced. The thermostat is arranged to simultaneously control a flow of the coolant through the engine block water jacket and through the radiator when the coolant exceeds a predetermined threshold temperature.

The individual components of the split coolant circuit are advantageously connected to one another in a different manner than in the prior art, so as to considerably reduce the dissipation of heat from the engine block during its warm-up phase. This leads to higher material and oil temperatures, thereby reducing friction and thermal losses. The advantageous design of the coolant circuit according to the invention combines the advantages of the split coolant circuit (fast warm-up), whereby the fuel consumption and the generation of harmful emissions are considerably reduced and the service life of the internal combustion engine is increased.

Another advantage of the present invention is that it uses the same components as in the conventional coolant circuit. The thermostat is arranged between the internal combustion engine and the heater core as viewed in the flow direction of the coolant in the present invention.

The thermostat is expediently connected to the engine block water jacket by a connecting line, with the engine block water jacket favorably being connected to the radiator.

The heater core is advantageously connected to the pump, with the radiator connected to the pump by a connecting line of the heater core.

As a result of the embodiment according to the invention of the split coolant circuit, in which the thermostat simultaneously controls the coolant flow both through the radiator and through the engine block water jacket, the thermostat can advantageously be embodied as a single-acting thermostat.

### BRIEF DESCRIPTION OF THE DRAWINGS

Further advantageous embodiments of the invention are disclosed in the subclaims and the following description of the figures, in which:

FIG. 1 shows a prior art coolant circuit in which the thermostat is closed;

FIG. 2 shows the thermostat of FIG. 1 in the open state;

FIG. 3 shows a sketch of a split coolant circuit with a closed thermostat; and

FIG. 4 shows the thermostat of FIG. 3 in the open state.

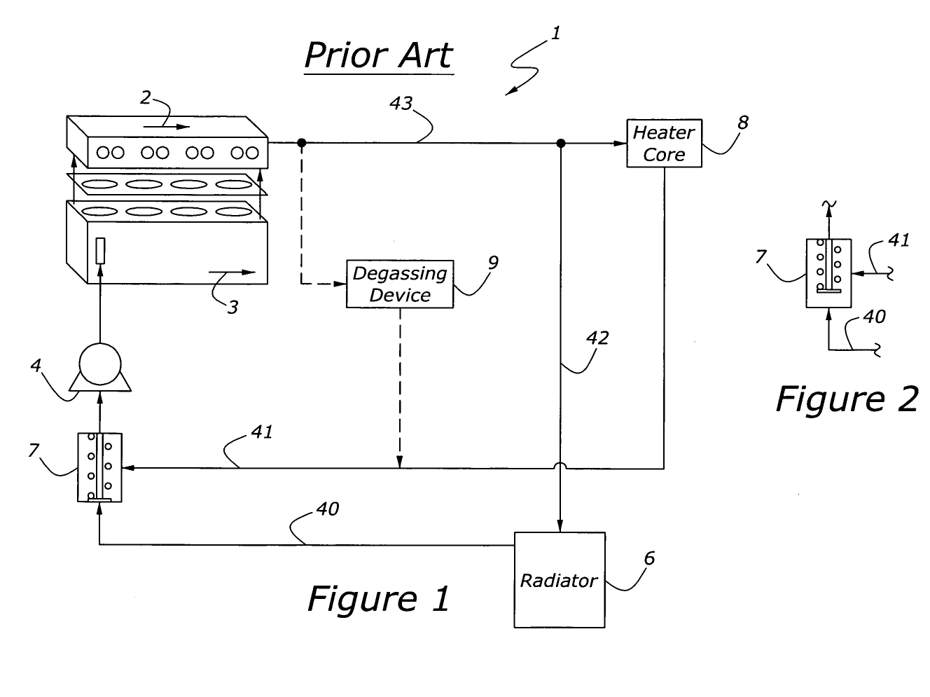

### DETAILED DESCRIPTION

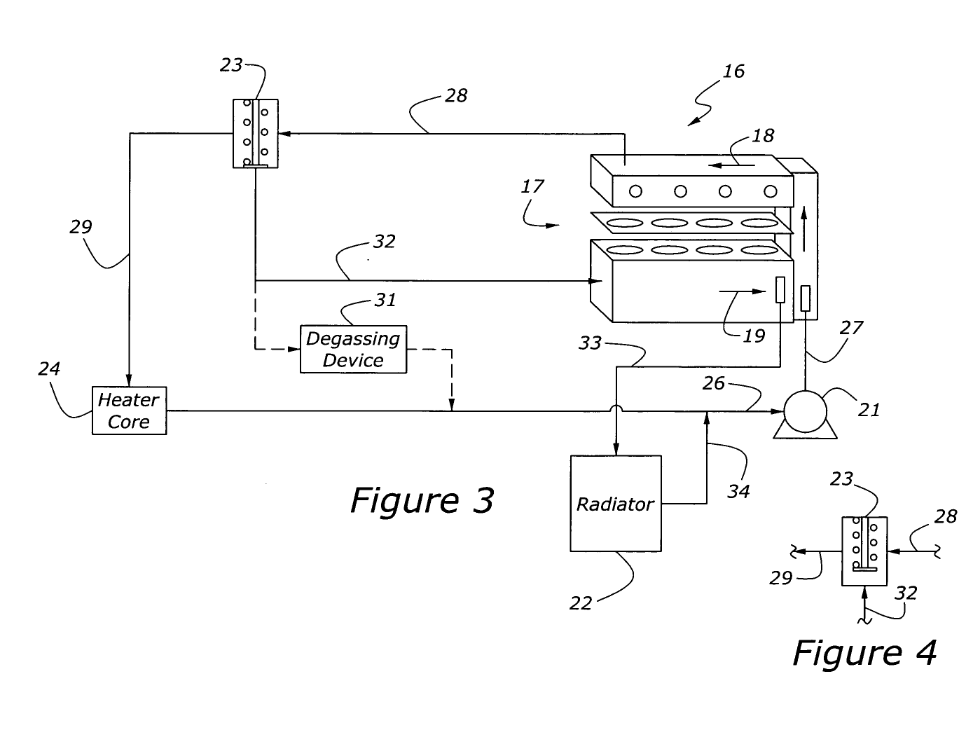

FIG. 3 shows a split coolant circuit 16 of an internal combustion engine 17 having a cylinder head water jacket 18 and an engine block water jacket 19. The split coolant circuit 16 has a pump 21, a radiator 22, a thermostat 23 and a heater core 24, having coolant circulating in the split coolant circuit 16. Thermostat 23 is arranged to simultaneously control flow of coolant through the engine block water jacket 19 and through the radiator 22 when the coolant exceeds a predetermined temperature.

In the illustrated exemplary embodiments, the thermostat is closed below a predetermined coolant temperature, shown in FIG. 3. The open thermostat is shown in FIG. 4. A typical predetermined coolant temperature is 90° C. and is provided by way of example and is not intended to be limiting.

Thermostat 23 is arranged between internal combustion engine 17 and heater core 24. Heater core 24 is connected by a connecting line 26 to pump 21. Pump 21 is connected by a connecting line 27 internal combustion engine 17. As shown in FIG. 3, coolant flows from pump 21 directly into cylinder head water jacket 18, and is supplied from there to thermostat 23 via a connecting line 28.

Thermostat 23, a single-acting thermostat, is closed at coolant temperatures below the predetermined temperature. Thus, the coolant is conducted through thermostat 23 directly to heater core 24 via connecting line 29. It is easily conceivable that a warm-up phase of the internal combustion engine 17 can be considerably reduced by such arrangement, since the engine block is not supplied coolant until the thermostat opens.

FIGS. 3 and 4 also show a degassing device 31, which is also known as an expansion tank.

If the coolant temperature exceeds the predetermined temperature, thermostat 23 opens allowing flow through connecting line 32 connected to engine block water jacket 19. Coolant flows through thermostat 23 to both heater core 24 and engine block water jacket 19. From the engine block water jacket 19, the coolant flows via a connecting line 33 to the radiator 22, with the coolant being cooled here in a similar way as in the heater core 24. The radiator 22 is connected by a connecting line 34 to the connecting line 26 of the heater core 24 to the pump 21, with connecting line 34 opening out into connecting line 26.

It can also be seen in FIG. 3 that degassing device 31 is placed in between connecting lines 32 and 26, connecting line 32 connecting block water jacket 29 with thermostat 23 and connecting line 26 connecting heater core 24 with pump 21.

The warmup phase of the internal combustion engine is considerably shortened, with said effect being obtained, using known components, but arranged differently. In particular, thermostat 23 is advantageously a cost-effective, single-acting thermostat.

While several modes for carrying out the invention have been described in detail, those familiar with the art to which this invention relates will recognize alternative designs and embodiments for practicing the invention. The above-describe embodiments are intended to be illustrative of the invention, which may be modified within the scope of the following claims.

We claim:

1. A cooling circuit for an internal combustion engine (17) having a cylinder head water jacket (18), an engine block water jacket (19), a pump (21), a thermostat (23), and a heater core (24) wherein the thermostat (23) is located downstream of the cylinder head water jacket (18) and upstream of the heater core (24) and the engine block water jacket (19).

2. The cooling circuit of claim 1 wherein the thermostat (23) opens when it attains a temperature above a predetermined threshold temperature, said thermostat arranged in the cooling circuit such that coolant flows to both said heater core (24) and engine block water jacket (19) when the thermostat (23) is in an open position and coolant flow to the engine block water jacket (19) is substantially curtailed when the thermostat is in a closed position.

3. The cooling circuit of claim 1, further comprising;
a radiator (22) arranged downstream of the engine block water jacket (29).

4. The cooling circuit of claim 1, further comprising a connecting line (26) between the pump (21) and the heater core (24).

5. The cooling circuit of claim 4 wherein the heater core (24) is arranged upstream of the pump (21).

6. The cooling circuit of claim 4 wherein a connecting line (34) from the radiator (22) tees into said connecting line (26) between the pump (21) and the heater core (24).

7. The cooling circuit of claim 1 wherein the thermostat (23) is a single-acting thermostat.

8. An internal combustion engine cooling circuit, comprising:
a thermostat (23) having three connections:
a first to a heater core (24) via a first connecting line (29];
a second to o a cylinder head water jacket (18) via a second connecting line (28); and
a third to an engine block water jacket (29) via a third connecting line [32].

9. The cooling circuit of claim 8 wherein said thermostat is closed below a predetermined temperature and open above said predetermined temperature.

10. The cooling circuit of claim 9 wherein flow through said third connecting line [32] is substantially closed off when said thermostat is its closed position.

11. The cooling circuit of claim 8, further comprising:
a pump (21) located upstream said cylinder head water jacket (18) and downstream of said heater core (24).

12. The cooling circuit of claim 11, further comprising:
a radiator (22) located downstream of said engine block water jacket (29), said radiator (22) connected to an inlet side of said pump (21).

13. A cooling circuit for an internal combustion engine, comprising:
a thermostat (23);
a heater core (24) arranged downstream of said thermostat (23) via a first connecting line (29);
a cylinder head water jacket (18) arranged upstream of said thermostat (23) via a second connecting line (28); and
a pump (21) connected downstream of said heater core (24) via a third connecting line (26).

14. The cooling circuit of claim 13 wherein said pump (21) supplies coolant to said engine (17) via a fourth connecting line (27), the flow from said fourth connecting line routed into said engine (17) to said cylinder head water jacket (18).
